(19) United States
(12) Patent Application Publication
(10) Pub. No.: US 2015/0254236 A1
(43) Pub. Date: Sep. 10, 2015

(54) Translation software built into internet

(71) Applicant: Michael Lewis Moravitz, Fairfax, VA (US)

(72) Inventor: Michael Lewis Moravitz, Fairfax, VA (US)

(21) Appl. No.: 14/545,502

(22) Filed: Mar. 13, 2014

(51) Int. Cl. G06F 17/28

(52) U.S. Cl. CPC G06F 17/289

(57) ABSTRACT

Automatic Translation Software Built into Internet portals.

Translation software could be built into computers in the software of Internet portals to translate websites into English from different languages and vice versa.

Key computer makers with different languages around the world could use similar software. Translation software for key languages, such as the Romance languages, might be the most easily manufactured and installed into CPUs. Other languages, in different alphabets, would also be possible since this translation software has been available on the Google website. Improving it and installing it on individual computers would make the software more profitable. The software would ease commerce and information exchanges, and level the playing field for businesses in different countries that do business in foreign languages and vice versa.

1. Builds on Internet Translation Software.
